(19) United States
(12) Patent Application Publication
(10) Pub. No.: US 2013/0120613 A1
(43) Pub. Date: May 16, 2013

(54) COMPUTER-READABLE STORAGE MEDIUM STORING AN IMAGE CAPTURING PROGRAM, IMAGE CAPTURING DEVICE, IMAGE CAPTURING SYSTEM, AND IMAGE DISPLAY METHOD

(71) Applicant: NINTENDO CO., LTD., Kyoto (JP)

(72) Inventor: Masahiro NITTA, Kyoto (JP)

(73) Assignee: NINTENDO CO., LTD., Kyoto (JP)

(21) Appl. No.: 13/669,974

(22) Filed: Nov. 6, 2012

(30) Foreign Application Priority Data
Nov. 15, 2011 (JP) 2011-249396

(51) Int. Cl. H04N 5/76

(52) U.S. Cl. 348/231.99; 348/E05.031

(57) ABSTRACT

An exemplary image capturing device includes: a camera, an upper display device for enabling a user to see an image capturing target (a background and an object) of the camera, and a save data memory. The image capturing device generates moving image data using captured-images continuously captured by the camera, and stores the moving image data in the save data memory. Based on a predetermined set of frame data out of a plurality of sets of frame data constituting the moving image data stored in the save data memory, the image capturing device displays on the upper display device a predetermined static image to enable the user to see the image capturing target.

### CROSS REFERENCE TO RELATED APPLICATION

The present application claims priority from Japanese Patent Application No. 2011-249396, which was filed on Nov. 15, 2011, the disclosure of which is herein incorporated by reference in its entirety.

### FIELD

The technical field herein relates to a computer-readable storage medium storing an image capturing program for storing a moving image captured, an image capturing device, an image capturing system, and an image display method.

### BACKGROUND AND SUMMARY

Traditionally, there have been widely known an image capturing device capable of capturing a moving image, and save (store) this moving image captured. An example of such a known image capturing device captures a moving image of an image capturing target such as an object, a background, or the like displayed in a finder (video display device), assuming a range from a point of receiving a user-instruction to start image capturing to a point of receiving a user-instruction to end the image capturing as one scene.

Once the image capturing device ends (pauses, stops or the like) capturing and saving of a moving image, the user may wish to grasp the content of the moving image saved, for the sake of capturing and saving of the subsequent moving image. For example, in cases where the content of the moving image to be captured and saved subsequently is continuous from the content of the moving image having been saved, the user wishes to grasp the content of that moving image having been saved.

It is therefore an object of the technology herein to provide an image capturing program, an image capturing device, an image capturing system, and an image display method, each of which enables a user to grasp the content of a moving image saved (stored), and then capture and save the subsequent moving image.

(1) An example is a computer-readable non-transitory storage medium, storing an image capturing program configured so that a computer of an image capturing device including an image capturing unit, a finder for enabling a user to see an image capturing target of the image capturing unit, and a storage functions as a moving image storage, and a display controller. The moving image storage is configured to store in the storage a moving image captured by the image capturing unit. The display controller is configured to display on the finder a predetermined static image out of static images constituting a moving image stored in the storage, to enable the user to see the image capturing target.

In the above structure, the predetermined static image out of static images constituting a stored moving image is displayed on the finder so that the user is able to see the image capturing target. This enables the user to grasp the content of the stored moving image. The user therefore is able to adjust the position and/or the posture, or the like of the image capturing target on the finder, in consideration of the content of the stored moving image. Note that the image capturing target is a target or a scope the user wish to capture, and is a background, an object, or the like positioned within an area of image capturing by the image capturing unit.

(2) The above-described image capturing program may be adapted so that, of the static images constituting a moving image stored in the storage, the display controller displays as the predetermined static image at least one of a static image captured at last and a static image arbitrarily selected by the user, on the finder.

In the above structure, at least one of a static image captured at last and a static image arbitrarily selected by the user is displayed on the finder to enable the user to see the image capturing target. This enables the user to grasp the content of the static image captured at last or the content of the static image selected. It is therefore possible to adjust the position and/or the posture, or the like of the image capturing target, based on the content of the static image captured at last or the content of the static image selected. For example, when the user, by using the image capturing device, wishes to capture a moving image whose content is continuous with the content of the static image captured at last, or continuous with the content of the static image selected, and to store the moving image, the user is able to easily adjust the position and the posture of the image capturing target for this subsequent moving image.

(3) The above-described image capturing program may be adapted so that the display controller displays the predetermined static image on the finder to enable the user to see the both predetermined static image and the image capturing target overlapped with each other. With this structure, the user is able to easily adjust the position and the posture, or the like of the image capturing target (e.g., the position and the posture of the object), based on the content of the predetermined static image (e.g., the position and the posture of the object). For example, this facilitates the user to adjust the position and/or the posture of the object in the image capturing target so that the object in the image capturing target overlaps with the object in the predetermined static image.

(4) The above-described image capturing program may be adapted so that the display controller makes the predetermined image semi-transparent and displays the predetermined static image on the finder. In this structure, since the predetermined static image is made semi-transparent, the user is able to see the entire image capturing target through the semi-transparent predetermined static image even when looking at the predetermined static image and the image capturing target overlapped with each other. With this structure, the user is able to more easily adjust the position and the posture, or the like of the image capturing target (e.g., the position and the posture of the object), based on the content of the predetermined static image (e.g., the position and the posture of the object).

(5) The above-described image capturing program may be adapted so that the image capturing device includes an operation unit. Further, when the operation unit receives a predetermined user operation by the user, the display controller may display the predetermined static image on the finder to enable the user to see the image capturing target. Examples of the predetermined user operation include: a pause operation to pause the process of storing a captured moving image; a stop operation for stop storing the captured moving image; and a display instructing operation for the user to instruct displaying of the predetermined static image. With this structure, since the predetermined static image is displayed based on the predetermined user operation, it is possible to display the predetermined static image at a specific timing where displaying of the predetermined static image is needed (at a timing of receiving the display instructing operation by the operation unit, or the like), or at a specific timing when displaying of the predetermined static image is effective (at a timing of receiving a pause operation or a stop operation by the operation unit, or the like).

(6) The above-described image capturing program may be adapted so that the predetermined user operation is a pause operation or a stop operation. The moving image storage may repetitively execute a storing process of storing in the storage a moving image captured by the image capturing unit, and may pause the storing process when the pause operation is received by the operation unit Further, the moving image storage may stop the storing process when the operation unit receives the stop operation. The display controller may display on the finder a static image captured immediately before the pausing or the stopping, as the predetermined static image.

In the above structure, when the storing process is paused or stopped, the static image captured immediately before the pausing or the stopping is displayed along with the image capturing target on the finder. This enables the user to easily grasp the content of the static image captured immediately before the pausing or the stopping. Thus, for example, when the user, by using the image capturing device, wishes to capture the subsequent moving image after the pausing or the stopping, the user is able to adjust the position and the posture, or the like of the image capturing target (e.g., the position and/or the posture of the object), based on the content of the static image captured immediately before the pausing or the stopping (e.g., the position and/or the posture of the object), for the image capturing of the subsequent moving image.

(7) The above-described image capturing program may be adapted so that, of moving images stored in the storage, the display controller displays a moving image including the predetermined static image on the finder, and then displays the predetermined static image on the finder to enable the user to see the image capturing target. This structure enables the user to sufficiently grasp the content of the moving image stored in the storage. Further, when the predetermined static image is a static image arbitrarily selected by the user, the user is able to select the predetermined static image based on the moving image displayed. This facilitates arbitrary selection of the static image by the user.

(8) Another example is an image capturing device, including: an image capturing unit; a finder configured to enable a user to see an image capturing target of the image capturing unit; a storage; a moving image storage; and a display controller. The moving image storage is configured to store in the storage a moving image captured by the image capturing unit. The display controller is configured to display on the finder a predetermined static image out of static images constituting a moving image stored in the storage, to enable the user to see the image capturing target.

(9) Yet another example is an image capturing system including an image capturing unit; a finder configured to enable a user to see an image capturing target of the image capturing unit; a storage; a moving image storage; and a display controller. The moving image storage is configured to store in the storage a moving image captured by the image capturing unit. The display controller is configured to display on the finder a predetermined static image out of static images constituting a moving image stored in the storage, to enable the user to see the image capturing target. This image capturing system is structured by a plurality of devices (e.g., a plurality of information processing devices; one information processing device and a peripheral device or the like).

(10) Yet another example is an image display method involving an image capturing device including an image capturing unit, a finder for enabling a user to see an image capturing target of the image capturing unit, and a storage. This image display method includes a moving image storing step and a display control step. In the moving image storing step, a moving image captured by the image capturing unit is stored in the storage. In the display control step, a predetermined static image out of static images constituting a moving image stored in the storage is displayed on the finder to enable the user to see the image capturing target.

With the structures of the image capturing device, the image capturing system, and the image display method of the above (8) to (10), it is possible to achieve the similar actions and effect achieved by the computer-readable storage medium of the above (1) storing the image capturing program.

With the examples thus described above, the user is able to grasp the content of the stored moving image. The user therefore is able to adjust the position and/or the posture, or the like of the image capturing target (e.g., the position and/or the posture of the object) on the finder, in consideration of the content of the stored moving image.

### BRIEF DESCRIPTION OF THE DRAWINGS

FIG. 1 shows an example non-limiting block diagram showing an internal structure of an image capturing device related to a first embodiment.

FIG. 2A shows an example non-limiting saved-image used for generating moving image data.

FIG. 2B shows an example non-limiting saved-image used for generating moving image data.

FIG. 2C shows an example non-limiting saved-image used for generating moving image data.

FIG. 3A shows an example non-limiting realtime captured-image not combined with a saved-image captured immediately before the moving image saving process is paused.

FIG. 3B shows an example non-limiting realtime captured-image combined with a saved-image captured immediately before the moving image saving process is paused.

FIG. 3C shows an example non-limiting realtime captured-image combined with a saved-image captured immediately before the moving image saving process is paused.

FIG. 4A shows an example non-limiting memory map of a save data memory.

FIG. 4B shows an example non-limiting memory map of a main memory.

FIG. 5A shows an example non-limiting flowchart (part 1) of the main process in an image capturing process.

FIG. 5B shows an example non-limiting flowchart (part 2) of the main process in an image capturing process.

FIG. 6 shows an example non-limiting flowchart of a moving image saving process.

FIG. 7 shows an example non-limiting flowchart of an image combining process.

FIG. 8 shows an example non-limiting flowchart of a main process related to a second embodiment.

### DETAILED DESCRIPTION OF NON-LIMITING EXAMPLE EMBODIMENTS

### First Embodiment

The following describes a first embodiment with reference to attached drawings.

[Structure of Image Capturing Device 1]

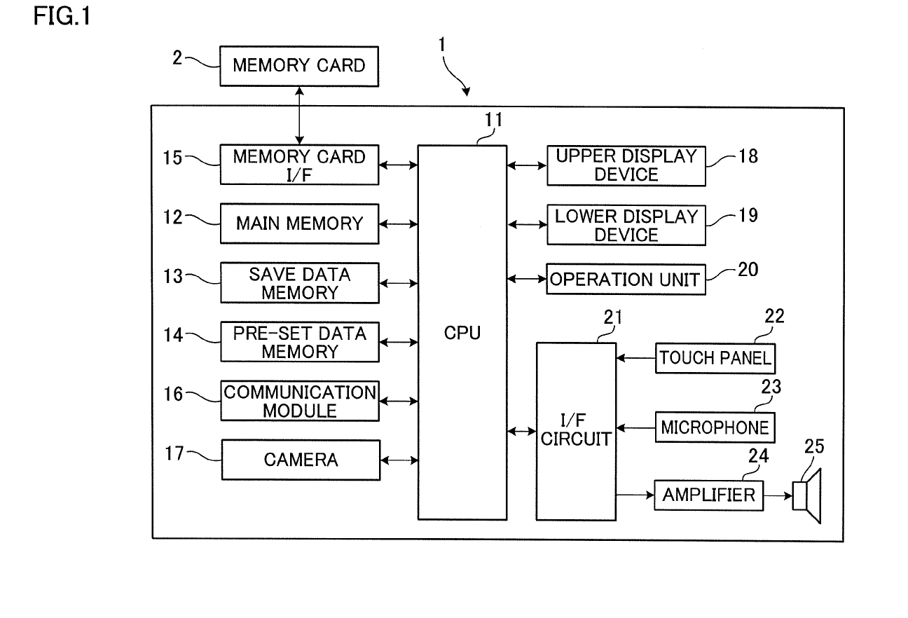

FIG. 1 shows an example non-limiting block diagram showing an internal structure of an image capturing device related to a first embodiment. The image capturing device 1 includes a CPU 11, a main memory 12, save data memory 13, a pre-set data memory 14, a memory card interface (memory card I/F) 15, a communication module 16, a camera 17, an upper display device 18, a lower display device 19, an operation unit 20, an interface circuit (I/F circuit) 21, and the like.

The CPU 11 is connected, via not-shown buses, to the main memory 12, the save data memory 13, the pre-set data memory 14, the memory card I/F 15, the communication module 16, the camera 17, the upper display device 18, the lower display device 19, the operation unit 20, the I/F circuit 21, and the like.

The CPU 11 conducts predetermined information processing by running a predetermined program. For example, the CPU 11 functions as a moving image storage and a display controller, and by running a later-described image capturing program, executes an image capturing process which saves (stores) a moving image captured by using the camera 17 as the moving image data in the save data memory 13. This image capturing process is detailed later. Further, by running a reproduction program, the CPU 11 executes a reproduction process which reproduces moving image data stored in the save data memory 13 through the image capturing process. The main memory 12 functions as a work area for the CPU 11. Thus, the main memory 12 stores: a predetermined program obtained by the CPU 11 from the outside via a memory card I/F 15, a communication module 16, or the like; and/or various data used in the predetermined information processing. For example, PSRAM (Pseudo-SRAM) is adoptable as this main memory 12.

The save data memory 13 is a rewritable and nonvolatile memory, and functions as a storage. For example a NAND flash memory is adoptable as the save data memory 13. The pre-set data memory 14 is a nonvolatile memory, and is a memory for storing a boot program of the image capturing device 1, pre-set parameters, or the like. For example, a flash memory is adoptable as the pre-set data memory 14.

To the memory card I/F 15 is detachably connected the memory card 2 (example of the storage). To and from this memory card 2, the memory card I/F 15 writes and reads data according to instructions from the CPU 11. Note that the image capturing device 1 may be structured so that another storage medium is connectable thereto, in place of or in addition to the memory card 2. For example, the image capturing device 1 may be structured so that the following storage media are connectable thereto: another semiconductor memory type storage medium; a storage medium (CD-ROM, DVD, or the like) adopting an optical recording method; a storage medium (magnetic tape, Floppy® disk, hard disk, magnetic card, or the like) adopting magnetic recording method.

The communication module 16 has a function of conducting wireless communication with another information processing device, in compliance with a communication standard of IEEE802.11b/g, or the like. Note image capturing device 1 may conduct wired communication with another information processing device (a server, an image capturing device of the same type, or the like), in place of or in addition to the wireless communication.

The camera 17 functioning as an image capturing unit has, for example, a color filter, a CCD (Charge Coupled Device), an image capturing lens, an aperture, and the like, and has a function of capturing an image according to an instruction from the CPU 11. The camera 17 further functions as a digital video camera which captures a moving image, and conducts continuous shooting at a predetermined shutter speed (e.g., 1/60 sec). In the first embodiment, conducting of the continuous shooting is expressed as “capturing a moving image”. Further, a static image captured by the camera 17 is referred to as “captured-image”. A plurality of captured-images obtained by the continuous shooting, and a captured-image taken first in the continuous shooting are referred to as “captured moving image”. The camera 17 converts the analog signals (output signals from the CCD) representing a captured-image into digital data (captured-image data) and outputs the digital data to the CPU 11.

For example, the upper display device 18 and the lower display device 19 are each a liquid crystal display device having a liquid crystal display, and the upper display device 18 is disposed be positioned above the lower display device 19. In the first embodiment, the upper display device 18 functions as an electronic finder configured to display in real time an image capturing target such as an object and a background captured by an image capturing element of the camera 17. Note that the “finder” of the first embodiment is means for displaying in real time the image capturing target by the camera 17. By viewing the finder, the user is able to grasp the image capturing target by the camera 17 and adjust the layout of the image capturing target (e.g., the position, the posture, or the like of the object).

Of the electronic finders, the following description deals with a method in which the upper display device 18 functions as a liquid crystal finder. In the image capturing process, the CPU 11 generates frame data at every predetermined cycle (e.g., at every drawing cycle of 1/60 sec) using the captured-image data obtained from the camera 17. The frame data is, for example, bitmap data indicating color information (R, G, B) of each pixel. Based on the frame data generated, the CPU 11 displays the captured-image in real time on the upper display device 18. This realtime display of the captured-image enables realtime display of the image capturing target to the user. Thus, while viewing the upper display device 18 as a finder, the user is able to adjust the layout of the image capturing target (e.g., the position, the posture, or the like of the object).

Note that the lower display device 19 may function as the finder, in place of the upper display device 18. Further, of the electronic finders, the first embodiment adopts a liquid crystal finder as the finder; however, a liquid crystal view finder (EVF) is also adoptable. Further, instead of adopting an electronic finder, it is possible to adopt as the finder an optical finder (real image type, single lens reflex type) which enables the user to directly see through an ocular lens an image having passed through a finder lens or an image capturing lens.

Using the frame data generated as described above, the CPU 11 generates moving image data. In the image capturing process, the CPU 11 generates the moving image data when instructed by the user, and does not always generate the moving image data. In response to an instruction by the user, the CPU 11 generates moving image data and store this moving image data in the save data memory 13. As hereinabove described, the frame data is generated at every predetermined cycle (e.g., at every 1/60 sec). The CPU 11 therefore updates the moving image data stored in the save data memory 13 every time the frame data is generated so that the moving image data contains the frame data generated. Note that the “storing process of storing in the storage a moving image captured” corresponds to “a process of generating moving image data, a process of storing this moving image data generated in the save data memory 13, and a process of updating the moving image data stored in the save data memory 13 with the moving image data generated” in the first embodiment. This process is hereinafter referred to as “moving image saving process”.

The operation unit 20 has one or a plurality of operation components for receiving user operations. The user operations include, for example: an “image capturing mode start operation”, a “record instructing operation”, a “pause operation”, a “stop operation”, and an “image capturing mode end operation”. The “image capturing mode start operation” is an operation for causing the CPU 11 to start the image capturing process (start an image capturing mode). The “record instructing operation” is an operation acceptable during the image capturing process (image capturing mode), and is an operation for starting the moving image saving process to cause the CPU 11 to start generating and saving the moving image data. The “pause operation” is an operation for causing the CPU 11 to pause the moving image saving process. This “pause” is to temporarily stop the moving image saving process with respect to the same moving image data in a resumable manner. The “stop operation” is to cause the CPU 11 to stop the moving image saving process, and is an operation for causing the CPU 11 to stop generating and saving the moving image data. Note that the “stop” is to end the moving image saving process with respect to the same moving image data in a non-resumable manner. The “image capturing mode end operation” is an operation for causing the CPU 11 to end the image capturing process (end the image capturing mode).

Note that a period from a point of receiving the pause operation to a point of receiving the record instructing operation or the stop operation is expressed as “pausing state” in the first embodiment. Further, a period from a point of receiving the record instructing operation to a point of receiving the stop operation, excluding the period of “pausing state” is expressed as “recording state”.

Further, the image capturing device 1 has a touch panel 22, a microphone 23, an amplifier 24, and a speaker 25, and is connected to a touch panel 22, a microphone 23, an amplifier 24, and the I/F circuit 21.

The I/F circuit 21 includes a touch panel control circuit configured to control the touch panel 22 and an audio control circuit configured to control the microphone 23 and the amplifier 24. The touch panel control circuit generates at every predetermined cycle position information indicating the coordinates of a position of the touch panel 22 touched by the user, based on a signal from the touch panel 22. The touch panel control circuit then outputs this position information to the CPU 11. The audio control circuit converts the audio signals of a sound collected by the microphone 23 into digital signals and outputs the digital signals to the CPU 11, based on instructions from the CPU 11. Further, the audio control circuit executes a predetermined audio signal processing with respect to audio data input by the CPU 11 based on the instructions from the CPU 11, converts the audio data processed into analog data, and outputs the analog audio data converted to the amplifier 24.

The touch panel 22 outputs signals to the I/F circuit 21 based on touch operations by the user. The microphone 23 collects sound and outputs audio signals to the I/F circuit 21, based on the collected sound. The amplifier 24 connects to the speaker 25, amplifies the audio signals input via the I/F circuit 21, and outputs the amplified signals to the speaker 25. The speaker 25 outputs sound input from the amplifier 24.

[Overview of Image Capturing Process]

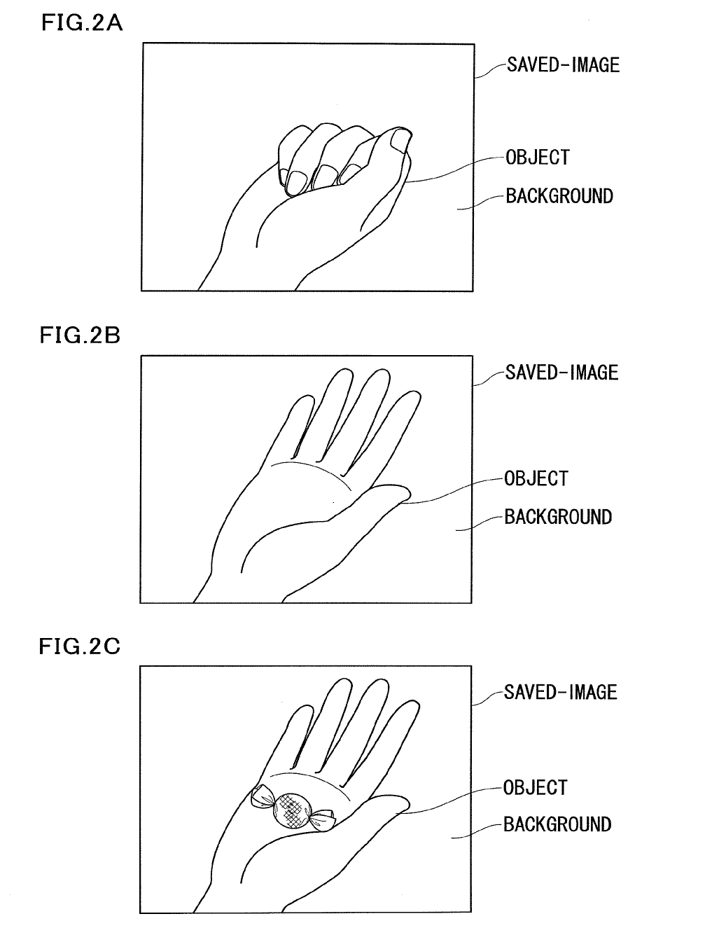

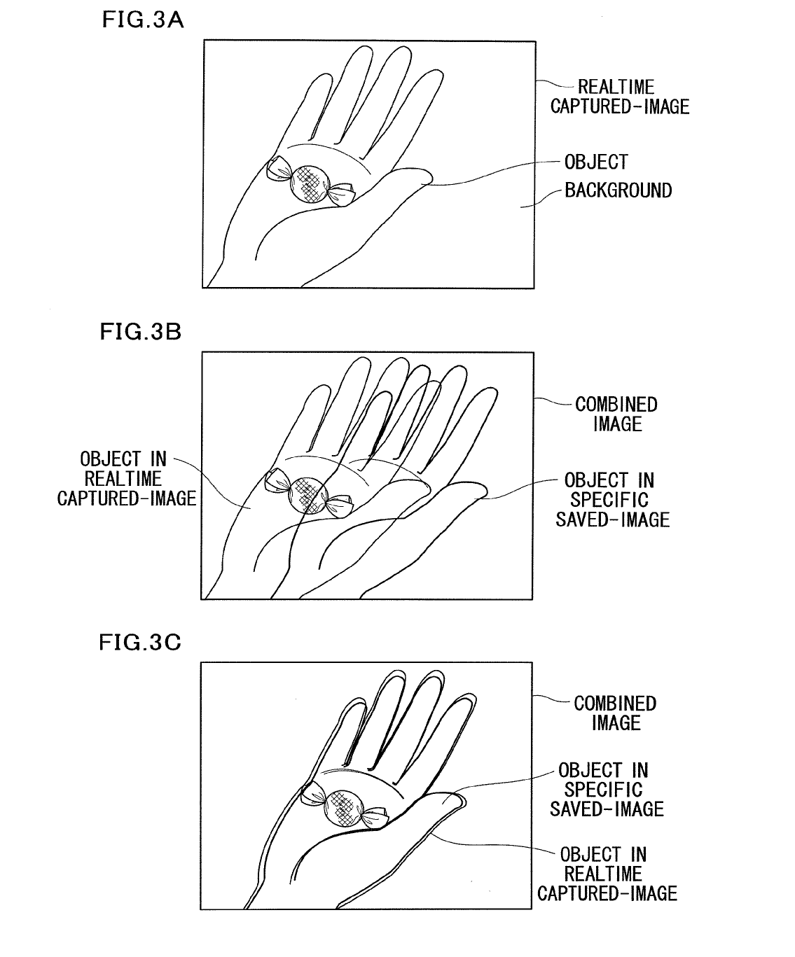

With reference to FIG. 2A to FIG. 3B, the following describes an overview of the image capturing process executed by the image capturing device 1. In the image capturing process, the camera 17 captures a moving image by conducting the continuous shooting at a predetermined shutter speed to obtain captured-images. Then, the upper display device 18 serving as the finder successively displays in real time the captured-images obtained. The captured-images displayed in real time are hereinafter referred to as “realtime captured-images”.

The above described moving image saving process is repetitively executed when the operation unit 20 receives the record instructing operation. Specifically, moving image data containing a realtime captured-image (moving image data containing frame data of the realtime captured-image) is first generated and stored in the save data memory 13. Note that the captured-image contained in the moving image data is referred to as “saved-image”. After that, new moving image data is generated so as to contain newly generated frame data, at every predetermined cycle, and the moving image data in the save data memory 13 is updated with this new moving image data.

When the operation unit 20 receives the pause operation, the moving image saving process is paused. When the operation unit 20 once again receives the record instructing operation during this pausing state, the moving image saving process is resumed. Further, the moving image saving process is ended when the operation unit 20 receives the stop operation, during the pausing state or recording state.

Note that the moving image data generated from the point of receiving the first record instructing operation to a point of receiving the stop operation is stored in the save data memory 13 as the moving image data of one scene. That is, if the pause operation is received during the period from the point of receiving the first record instructing operation to the point of receiving the stop operation, the moving image data of one scene is constituted by the frame data generated before the pause operation and the frame data generated after the pause; i.e., when the recording is resumed. Thus, by conducting the record instructing operation once again after the pause operation, the user is able to cause the image capturing device 1 to continue updating of the moving image data in the save data memory 13.

The moving image data of one scene is described with a specific example. FIG. 2A to FIG. 2C each show an example non-limiting saved-image used for generating moving image data. The saved-image shown in FIG. 2A, the saved-image shown in FIG. 2B, and the saved-image shown in FIG. 2C are captured in this order. The moving image data of one scene in the specific example shows a scene in which a closed right hand (object) gradually opens, and a piece of candy suddenly appears on the right hand opened. In the process of generating this moving image data, the image capturing device 1 pauses the moving image saving process when the right hand is completely opened (FIG. 2B). The image capturing device 1 then resumes the moving image saving process when the record instructing operation by the user is received again.

The saved-image shown in FIG. 2B is an image captured immediately before the moving image saving process is paused. The saved-image shown in FIG. 2C is the first image captured after the moving image saving process is resumed. During the pausing state, in this specific example, the user positions the right hand in the position and the posture at the time of conducting the pause operation, places the candy on the palm, and then conducts the record instructing operation. As hereinabove described, the moving image data of one scene is generated using the frame data generated before the moving image saving process is paused and the frame data generated after the pause. In other words, the saved-image shown in FIG. 2B and the saved-image shown in FIG. 2C are continuously reproduced at the time of reproducing the moving image data. The moving image data of one scene in this specific example shows a scene like a magic show in which a piece of candy suddenly appears on an opened palm.

### Characteristics of Embodiment

Next, with reference to FIG. 3A to FIG. 3C, the following describes a characteristic of the first embodiment. During the pausing state in the first embodiment, a saved-image captured by the image capturing device 1 immediately before the moving image saving process is paused (e.g., saved-image shown in FIG. 2B) is displayed on the upper display device 18 along with the realtime captured-image. This enables the user to grasp the content of the moving image data stored in the save data memory 13. Further, in the first embodiment, the saved-image captured immediately before the pausing is combined (overlapped) with the realtime captured-image and displayed on the upper display device 18.

FIG. 3A shows an example non-limiting realtime captured-image not combined with the saved-image captured immediately before the pausing. FIG. 3B and FIG. 3C each show an example non-limiting realtime captured-image combined with the saved-image captured immediately before the pausing. Each of the realtime captured-images shown in FIG. 3B and FIG. 3C is illustrated as “combined image”. The combined image shown in FIG. 3B is a combination of the saved-image shown in FIG. 2B and the realtime captured-image shown in FIG. 3A. The combined image shown in FIG. 3C is a combination of the saved-image shown in FIG. 2B with another realtime captured-image different from the realtime captured-image shown in FIG. 3A.

The images shown in FIG. 3B and FIG. 3C are displayed during the pausing state in the specific example described above with reference to FIG. 2A to FIG. 2C. As shown in FIG. 3B and FIG. 3C, the saved-image captured immediately before the pausing is made semi-transparent and is combined with the realtime captured-image. Therefore, the user is able to see the realtime captured-image through the saved-image captured immediately before the pausing. This enables the user to grasp whether or not, and by how much, the realtime position and the realtime posture of the object (the object in the realtime captured-image) are different from those of the object (illustrated as “the object in the specific saved-image”) immediately before the moving image saving process is paused.

Thus, the user is able to adjust the position and the posture of the object based on the conditions grasped as described above. Note that the saved-image captured immediately before the moving image saving process is paused and the saved-image captured first immediately after the moving image saving process is resumed are continuously reproduced. For this reason, it is preferable that the position and the posture of the object in the saved-image captured immediately before the moving image saving process is paused and the position and the posture of the object in the saved-image captured first immediately after the moving image saving process is resumed be related to (e.g. matched with) each other. The first embodiment enables the user to adjust the position and the posture of the object in the realtime captured-image while looking at the realtime captured-image through the saved-image captured immediately before pause. Thus, the user is easily able to adjust the position and the posture of the object in the realtime captured-image so as to relate them to the position and the posture of the object in the saved-image captured immediately before the moving image saving process is paused. With the adjustment, even when the moving image saving process is paused, the content of the moving image before the pause and the moving image after the pause are related to each other (made continuous).

For example, when the position of the right hand (position of the object) in the saved-image captured immediately before the moving image saving process is paused does not match with the position of the same in the realtime captured-image, the combined image displayed will be as shown in FIG. 3B. By looking at this image, the user is able to grasp that the realtime position of the right hand is different from that in the saved-image captured immediately before the moving image saving process is paused, and grasp by how much the position of the right hand is different. When the position and the posture of the right hand (the posture of the object) in the saved-image captured immediately before the moving image saving process is paused substantially matches with the position of the same in the realtime captured-image, the combined image displayed will be as shown in FIG. 3C. Since the combined image displayed was as shown in FIG. 3B in this specific example, the user adjusts the position and the posture of the right hand, until the combined image as shown in FIG. 3C is displayed. By the user resuming the record instructing operation thereafter, the moving image data of one scene in this specific example will be generated so as to show a trick in which a piece of candy suddenly appears on the palm opened.

[Program and Data Stored in Image Capturing Device 1]

The following describes data stored in the save data memory 13 and programs and various data stored in the main memory 12, when the CPU 11 executes the image capturing process.

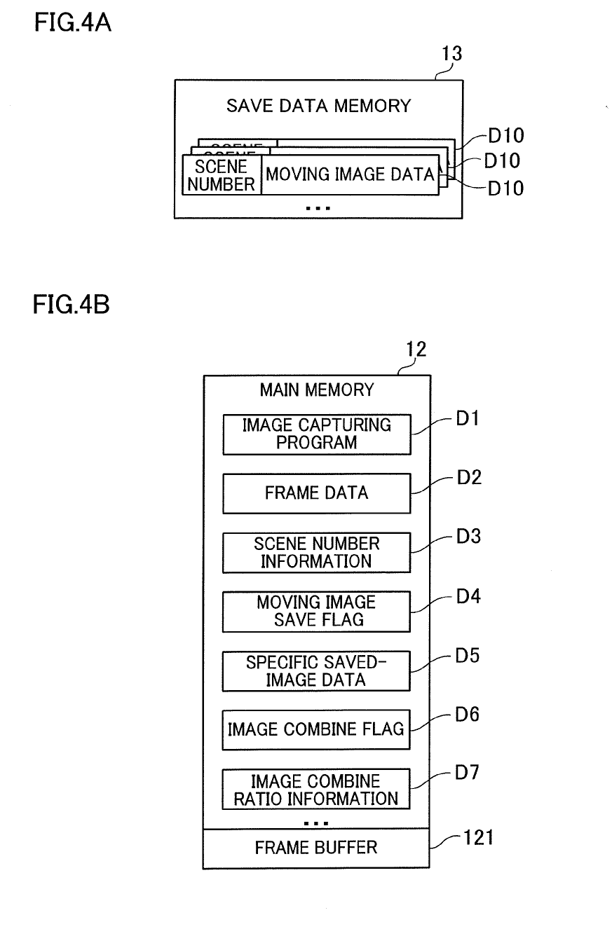

FIG. 4A shows an example non-limiting memory map of the save data memory 13. In the save data memory 13 is stored moving image data D10 or the like generated by the CPU 11. The moving image data D10 is given a scene number serving as identification information unique to the moving image data D10. The moving image data contains sets of frame data D2 (FIG. 4B) generated during the recording period, and serial frame numbers are given to the sets of frame data D2 in the order of generation. At the time of reproducing the moving image data D10, the sets of frame data D2 are sequentially read out in the order of the frame numbers, and the saved-images are displayed based on the sets of frame data D2 read out, thus displaying (reproducing) a moving image.

FIG. 4B shows an example non-limiting memory map of the main memory 12. The main memory 12 has a frame buffer 121 including an upper display drawing area for drawing an image to be displayed on the upper display device 18 and a lower display drawing area for drawing an image to be displayed on the lower display device 19.

Further, the main memory 12 stores an image capturing program D1 and running of the program stores the frame data D2, scene number information D3, a moving image save flag D4, specific saved-image data D5, an image combine flag D6, and an image combine ratio information D7.

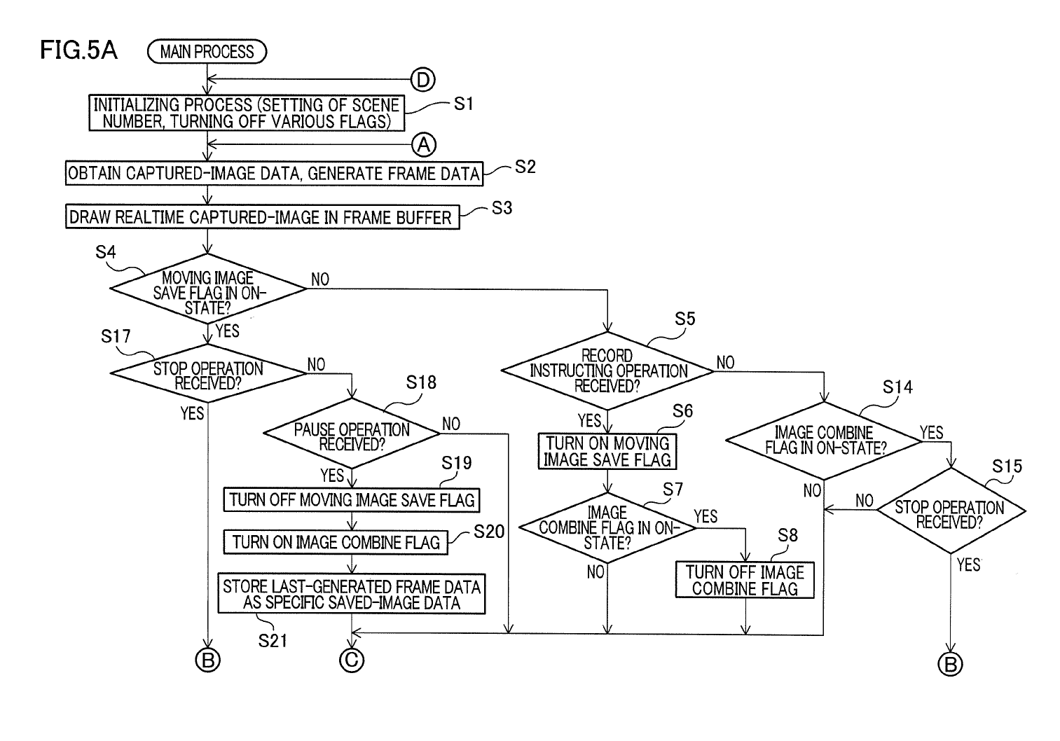

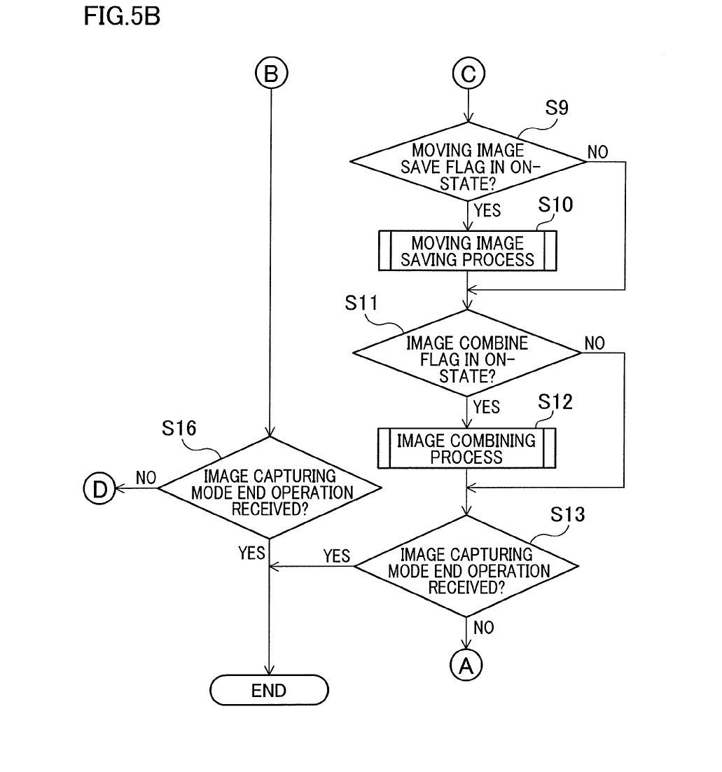

The image capturing program D1 is a program which causes the CPU 11 to execute the image capturing process. The details of the image capturing process are described later with reference to FIG. 5A to FIG. 7. The frame data D2 is bitmap data generated by the CPU 11 based on the captured-image data input from the camera 17. The realtime captured-image based on this frame data D2 is drawn in the upper display drawing area of the frame buffer 121. Further, during the recording state, the moving image data D10 is generated based on the frame data D2, and this moving image data D10 is stored in the save data memory 13. Note that, when corresponding moving image data D10 is already stored, the moving image data D10 in the save data memory 13 is updated with the generated moving image data D10.

The scene number information D3 indicates the scene number of the newly generated moving image data D10 or that of the moving image data D10 currently being updated. During the recording state, the moving image data D10, out of one or more sets of moving image data D10 stored in the save data memory 13, whose scene number is the scene number indicated by the scene number information D3 is updated. The moving image save flag D4 is a flag indicating whether to execute the moving image saving process. For example, the moving image save flag D4 indicates “1” or “0”, and the moving image save flag D4 is in the on-state when the moving image save flag D4 indicates “1”, whereas the moving image save flag D4 is in the off-state when the moving image save flag D4 indicates “0”. The moving image saving process is executed when the moving image save flag D4 is in the on-state.

The specific saved-image data D5 is frame data representing the saved-image displayed in combination with a realtime captured-image during the pausing state. The saved-image displayed in combination with a realtime captured-image is hereinafter referred to as “specific saved-image”. In the first embodiment, the specific saved-image is the saved-image captured immediately before the moving image saving process is paused. The image combine flag D6 is a flag indicating whether to display the specific saved-image. For example, the image combine flag D6 indicates “1” or “0”, and the on-state and the off-state of the image combine flag D6 are the same as those of the moving image save flag D4. The specific saved-image is displayed in combination with the realtime captured-image when the image combine flag D6 is in the on-state.

To combine the specific saved-image with the realtime captured-image, the CPU 11 executes a semi-transparency process (e.g. alpha blending). For example, the semi-transparency process is a process in which color information (R, G, B) of each pixel indicated by the specific saved-image data D5 and color information (R, G, B) of each pixel of the realtime captured-image drawn in the upper display drawing area of the frame buffer 121 are mixed at a predetermined ratio ((1−α):α) to generate new color information of each pixel, and this new color information is drawn in the upper display drawing area of the frame buffer 121. In the semi-transparency process, the image combine ratio information D7 is information indicating the predetermined ratio ((1−α):α) for mixing the two pieces of color information (R, G, B).

The above described image capturing program D1 is obtained from the outside via a storage medium such as a memory card 2 or the communication module 16, or stored in advance in the save data memory 13 at the time of shipping and read out and stored in the main memory 12 by the CPU 11 to execute the image capturing process. Needless to mention that the image capturing program D1 may be from the outside via a storage medium such as a memory card 2 or the communication module 16, and stored in the main memory 12. Further, the above described moving image data D10 may be stored in another rewritable and non-volatile memory, instead of the save data memory 13. For example, the moving image data D10 may be stored in a storage medium such as the memory card 2.

[Detailed Description of Image Capturing Process: Main Process]

The following details the image capturing process (image capturing mode) executed by the CPU 11, with reference to FIG. 4A, FIG. 4B, FIG. 5A to FIG. 7. FIG. 5A and FIG. 5B show an example non-limiting flowchart of the main process in the image capturing process. The image capturing process is executed by the CPU 11 when the operation unit 20 receives the image capturing mode start operation. In this image capturing process, a later-described step S2 and steps thereafter are repeated at a predetermined drawing cycle (every 1/60 sec) until it is determined in a later-described step S13 or S16 that the image capturing mode end operation is received, or until it is determined in a later-described step S15 or S17 that the stop operation is received.

The CPU 11 first executes a predetermined initializing process (S1). In this initializing process, the CPU 11 refers to the scene numbers given to the moving image data D10 in the save data memory 13, and generate scene number information D3 indicating a scene number not included in the scene numbers referred to, and store that information D3 in the main memory 12. Further, the CPU 11 switches the moving image save flag D4 and the image combine flag D6 to the off-state and stores these flags in the main memory 12 (turn off the moving image save flag D4 and the image combine flag D6).

After this, the CPU 11 obtains captured-image data from the camera 17, generates the frame data D2 using this captured-image data, and stores the frame data D2 in the main memory 12 (S2). The CPU 11 then draws a realtime captured-image based on this frame data D2 generated, in the upper display drawing area of the frame buffer 121 (S3). Thus, the realtime captured-image is displayed on the upper display device 18.

Then, the CPU 11 determines whether the moving image save flag D4 is in the on-state (S4). When it is determined that the moving image save flag D4 is in the off-state (S4: NO), the CPU 11 determines whether the record instructing operation is received by the operation unit 20 (S5). Note that step S4 resulting in NO means that the current state is not the recording state. Step S4 therefore results in NO in first-time processing of this step.

When it is determined that the record instructing operation is received (S5: YES), the CPU 11 switches the moving image save flag D4 to the on-state (turn of the moving image save flag D4) (S6). This way recording is started. Note that step S5 resulting in YES means that the record instructing operation is received by the operation unit 20, while the immediately previous state is not the recording state (e.g., when no record instructing operation is received from the point of executing the initial process in step S1, or when there was the record instructing operation, but the current state is in the pausing state).

Next, the CPU 11 determines whether the image combine flag D6 is in the on-state (S7). When it is determined that the image combine flag D6 is in the off-state (S7: NO), the CPU 11 causes the process to proceed to a later-described step S9. Note that step S7 resulting in NO means that the record instructing operation is received by the operation unit 20, while the immediately previous state is neither the recording state nor the pausing state (e.g., when no record instructing operation is received from the point of executing the initial process of step S1). On the other hand, when it is determined that the image combine flag D6 is in the on-state (S7: YES), the CPU 11 switches the image combine flag D6 to the off-state (S8) and causes the process to proceed to the subsequent step S9. Note that step S7 resulting in YES means that the record instructing operation is received by the operation unit 20, while the immediately previous state is the pausing state.

In step S9, the CPU 11 determines whether the moving image save flag D4 is in the on-state. Then, when it is determined that the moving image save flag D4 is in the on-state (S9: YES), the CPU 11 executes the moving image saving process (S10). In the moving image saving process, the CPU 11 generates the moving image data D10, using the frame data D2 generated in step S2. After that, the CPU 11 causes the process to proceed to a later-described step S11. On the other hand, when it is determined that the moving image save flag D4 is in the off-state (S9: NO), the CPU 11 causes the process to proceed to the later-described step S11 without executing the moving image saving process of step S10.

Note that the moving image save flag D4 is inevitably in the on-state when steps S5, S6, and S7 are executed (with step S7 resulting in NO), i.e., when the record instructing operation is received by the operation unit 20, while the immediately previous state is neither the recording state nor the pausing state (when no record instructing operation is received from the point of executing the initial process of step S1). Further, the moving image save flag D4 is inevitably in the on-state when steps S5, S6, S7, and S8 are executed, i.e., when the record instructing operation is received by the operation unit 20 while the immediately previous state is the pausing state. Therefore, in these cases, the recording state has been started. As such, the moving image saving process is executed and the moving image data D10 is generated.

In step S11, the CPU 11 determines whether the image combine flag D6 is in the on-state. Then, when it is determined that the image combine flag D6 is in the on-state (S11: YES), the CPU 11 executes the image combining process (S12). In the image combining process, the CPU 11 executes a process of displaying the specific saved-image in combination with the realtime captured-image. After that, the CPU 11 causes the process to proceed to the later-described step S13. On the other hand, when it is determined that the image combine flag D6 is in the off-state (S11: NO), the CPU 11 causes the process to proceed to the later-described step S13 without executing the image combining process of step S12.

Note that, the image combine flag D6 is inevitably in the off-state when steps S5, S6, and S7 are executed (with step S7 resulting in NO), i.e., when the record instructing operation is received by the operation unit 20 while the immediately previous state is neither the recording state nor the pausing state (when no record instructing operation is received from the point of executing the initial process of step S1). Further, the image combine flag D6 is also inevitably in the off-state when steps S5, S6, S7, and S8 are executed, i.e., when the record instructing operation is received by the operation unit 20 while the immediately previous state is the pausing state. Therefore, the image combining process is not executed in these cases, and the specific saved-image is not combined with the realtime captured-image.

In step S13, the CPU 11 determines whether the image capturing mode end operation is received by the operation unit 20. When it is determined that no image capturing mode end operation is received (S13: NO), the CPU 11 causes the process to return to step S2. When it is determined that the image capturing mode end operation is received on the other hand (S13: YES), the CPU 11 ends the image capturing process (image capturing mode).

The following describes a process executed by the CPU 11, when step S5 results in NO. Step S5 resulting in NO means that no record instructing operation is received and the immediately previous state is not the recording state. When it is determined that no record instructing operation is received (S5: NO), the CPU 11 determines whether the image combine flag D6 is in the on-state (S14).

When it is determined that the image combine flag D6 in the off-state (S14: NO), the CPU 11 execute the above-described step S9. That is the CPU 11 determines whether the moving image save flag D4 is in the on-state (S9). When it is determined that the moving image save flag D4 is in the on-state (S9: YES), the CPU 11 executes the moving image saving process (S10). After that, the CPU 11 causes the process to proceed to the later-described step S11. On the other hand, when it is determined that the moving image save flag D4 is in the off-state (S9: NO), the CPU 11 causes the process to proceed to the later-described step S11 without executing the moving image saving process of step S10. Note that step S14 resulting in NO means that the immediately previous state is neither the recording state nor the pausing state and that no record instructing operation is received. In this case, the moving image save flag D4 is inevitably set to the off-state. Therefore, the moving image saving process is not executed and the moving image data D10 is not generated.

In step S11, the CPU 11 determines whether the image combine flag D6 is in the on-state. When it is determined that the image combine flag D6 is in the on-state (S11: YES), the CPU 11 executes the image combining process (S12). Then, the CPU 11 causes the process to proceed to the later-described step S13. On the other hand, when it is determined that the image combine flag D6 is in the off-state (S11: NO), the CPU 11 causes the process to proceed to the later-described step S13, without executing the image combining process of step S12. Note that step S14 resulting in NO means that the immediately previous state is neither the recording state nor the pausing state and that no record instructing operation is received. During this state, the image combine flag D6 is set to the off-state. The image combining process therefore is not executed during this state, and the specific saved-image is not combined with the realtime captured-image.

In step S13, the CPU 11 determines whether the image capturing mode end operation is received. When it is determined that the image capturing mode end operation is received (S13: YES), the CPU 11 ends the image capturing process (image capturing mode), and when it is determined that no image capturing mode end operation is received (S13: NO), the CPU 11 causes the process to return to step S2.

The following describes a process executed by the CPU 11 when step S14 results in YES. When the image combine flag D6 is in the on-state, the immediately previous state is the pausing state. When the image combine flag D6 is in the on-state (S14: YES), the CPU 11 determines whether the stop operation is received by the operation unit 20 (S15).

When it is determined that no stop operation is received (S15: NO), the CPU 11 executes step S9. That is, the CPU 11 determines whether the moving image save flag D4 is in the on-state (S9). When it is determined that the moving image save flag D4 is in the on-state (S9: YES), the CPU 11 executes the moving image saving process (S10). The CPU 11 then causes the process to proceed to the later-described step S11. When it is determined that the moving image save flag D4 is in the off-state on the other hand (S9: NO), the CPU 11 causes the process to proceed to the later-described step S11 without executing the moving image saving process of step S10. Note that step S15 resulting in NO means that neither the record instructing operation nor the stop operation is received while immediately previous state is the pausing state. In this case, the pausing state is continued, and therefore the moving image save flag D4 is inevitably set to the off-state. The moving image saving process therefore is not executed in this case, and the moving image data D10 is not generated.

In step S11, the CPU 11 determines whether the image combine flag D6 is in the on-state. When it is determined that the image combine flag D6 is in the on-state (S11: YES), the CPU 11 executes the image combining process (S12). After that, the CPU 11 causes the process to proceed to the later-described step S13. On the other hand, when it is determined that the image combine flag D6 is in the off-state (S11: NO), the CPU 11 causes the process to proceed to the later-described step S13 without executing the image combining process of step S12. Note that step S15 resulting in NO means that the immediately previous state is the pausing state and that neither the record instructing operation nor the stop operation is received, as hereinabove described. In this case, the image combine flag D6 is inevitably set to the on-state. The image combining process therefore is executed and the specific saved-image is combined with the realtime image.

In step S13, the CPU 11 determines whether the image capturing mode end operation is received. When it is determined that the image capturing mode end operation is received (S13: YES), the CPU 11 ends the image capturing process, and when it is determined that no image capturing mode end operation is received (S13: NO), the CPU 11 causes the process to return to step S2.

The following describes a process executed by the CPU 11 when step S15 results in YES. When it is determined that the stop operation is received (S15: YES), the CPU 11 executes a process for stopping the recording. The CPU 11 then determines whether the image capturing mode end operation is received by the operation unit 20 (S16). Step S15 resulting in YES, the means that the stop operation is conducted, while the immediately previous state is the pausing state. When it is determined that no image capturing mode end operation is received (S16: NO), the CPU 11 causes the process to return to step S1. By returning the process to step S1, the scene number information D3 and the like are newly generated, and it becomes possible to newly generate moving image data D10 of one scene. Further, the CPU 11 brings back the state to the initial state in which the moving image save flag D4 and the image combine flag D6 are in the off-state and in which the moving image saving process and the image combining process are not executed. As described, by bringing back the state to the initial state and enabling newly generating of the moving image data D10 of one scene, the recording is stopped. On the other hand, when it is determined that the image capturing mode end operation is received (S16: YES), the CPU 11 ends the image capturing process (image capturing mode).

The following describes a process executed by the CPU 11 when step S4 results in YES. Step S4 resulting in YES means that the immediately previous state is the recording state. When it is determined that the moving image save flag D4 is in the on-state (S4: YES), the CPU 11 determines whether the stop operation is received by the operation unit 20 (S17). When it is determined that the stop operation is received (S17: YES), the CPU 11 executes a process for stopping the recording. Then, step S16 is executed. Note that step S17 resulting in YES means that the stop operation is conducted while the immediately previous state is the recording state. In step S16, the CPU 11 determines whether the image capturing mode end operation is received. When it is determined that the image capturing mode end operation is received (S16: YES), the CPU 11 ends the image capturing process, and when it is determined that the image capturing mode end operation is not received (S16: NO), the CPU 11 causes the process to return to step S1. Thus, as hereinabove described, bringing back the state to the initial state enables newly generating of the moving image data D10 of one scene, thus stopping the recording.

On the other hand, when it is determined that no stop operation is received (S17: NO), the CPU 11 determines whether the pause operation is received by the operation unit 20 (S18). When it is determined that no pause operation is received (S18: NO), the CPU 11 executes step S9. In other words, the CPU 11 determines whether the moving image save flag D4 is in the on-state (S9). When it is determined that the moving image save flag D4 is in the on-state (S9: YES), the CPU 11 executes the moving image saving process (S10). After that, the CPU 11 causes the process to proceed to the later-described step S11. When it is determined that the moving image save flag D4 is in the off-state on the other hand (S9: NO), the CPU 11 causes the process to proceed to the later-described step S11 without executing the moving image saving process of step S10. Note that step S18 resulting in NO means that the immediately previous state is the recording state and that neither the pause operation nor the stop operation is conducted. Since the recording state is continued in this case, the moving image save flag D4 is inevitably set to the on-state. Therefore, in this case, the moving image saving process is executed and the moving image data D10 is generated.

In step S11, the CPU 11 determines whether the image combine flag D6 is in the on-state. When it is determined that the image combine flag D6 is in the on-state (S11: YES), the CPU 11 executes an image combining process (S12). After that, the CPU 11 causes the process to proceed to the later-described step S13. When it is determined that the image combine flag D6 is in the off-state on the other hand (S11: NO), the CPU 11 causes the process to proceed to the later-described step S13 without executing the image combining process of step S12. Note that step S18 resulting in NO means that the immediately previous state is the recording state and that neither the pause operation nor the stop operation is conducted. Since the recording state is continued in such a case, the image combine flag D6 is inevitably set to the off-state. The image combining process therefore is not executed in this case, and the specific saved-image is not combined with the realtime image.

In step S13, the CPU 11 determines whether the image capturing mode end operation is received. When it is determined that the image capturing mode end operation is received (S13: YES), the CPU 11 ends the image capturing process, and when it is determined that no image capturing mode end operation is received (S13: NO), the CPU 11 causes the process to return to step S2.

The following describes a process executed by the CPU 11 when step S18 results in YES. When it is determined that the pause operation is received (S18: YES), the CPU 11 sets the moving image save flag D4 to the off-state (turn off the moving save flag D4) (S19) and then sets the image combine flag D6 to the on-state (turn on the image combine flag D6) (S20). This temporarily stops the recording state and starts the pausing state. Then, of all the sets of frame data D2 constituting the moving image data D10, the CPU 11 stores in the main memory 12 the last-generated set of frame data D2 as the specific saved-image data D5 (S21). In other words, the set of frame data D2 to serve as the specific saved-image data D5 is the frame data D2 generated in step S2 in the previous (immediately previous) drawing process, not the frame data D2 generated in the current drawing process.

The CPU 11 then executes step S9. That is, the CPU 11 determines whether the moving image save flag D4 is in the on-state (S9). When it is determined that the moving image save flag D4 is in the on-state (S9: YES), the CPU 11 executes the moving image saving process (S10). The CPU 11 then causes the process to proceed to the later-described step S11. When it is determined that the moving image save flag D4 is in the off-state on the other hand (S9: NO), the CPU 11 causes the process to proceed to the later-described step S11 without executing the moving image saving process of step S10. Steps S18 resulting in YES and steps S19, S20, and S21 being executed mean that the pause operation is conducted while the immediately previous state is the recording state. In this case, since the recording state is temporarily stopped and the pausing state is started, the moving image save flag D4 is inevitably set to the off-state in step S19. Therefore, the moving image saving process is not executed (the process is paused), and no moving image data D10 is generated.

In step S11, the CPU 11 determines whether the image combine flag D6 is in the on-state. When the image combine flag D6 is in the on-state (S11: YES), the CPU 11 executes the image combining process (S12). After that, the CPU 11 causes the process to proceed to the later-described step S13. On the other hand, when it is determined that the image combine flag D6 is in the off-state (S11: NO), the CPU 11 causes the process to proceed to the later-described step S13 without executing the image combining process of step S12. Step S18 resulting in YES and steps S19, S20, and S21 being executed mean that the pause operation is conducted while the immediately previous state is the recording state, as hereinabove described. In this case, the recording state is ended and the pausing state is started, and the image combine flag D6 is inevitably set to the on-state in step S20. Thus, in this case, the image combining process is executed to combine the specific saved-image based on the specific saved-image data D5 stored in the main memory 12 with the realtime image.

In step S13, the CPU 11 determines whether or not the image capturing mode end operation is received (S13). When it is determined that the image capturing mode end operation is received (S13: YES), the CPU 11 ends the image capturing process, and when it is determined that no image capturing mode end operation is received (S13: NO), the CPU 11 causes the process to return to the step S2.

[Detailed Description of Image Capturing Process: Moving Image Saving Process]

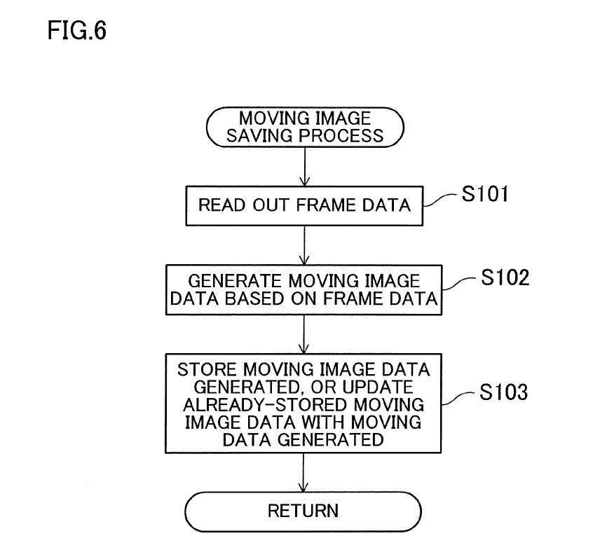

Next, the following describes the moving image saving process in step S10 with reference to FIG. 4A, FIG. 4B, and FIG. 6. FIG. 6 shows an example non-limiting flowchart of the moving image saving process. First, the CPU 11 reads out the frame data D2 which is generated in step S2 shown in FIG. 5 and stored in the main memory 12 (S101).

After that, the CPU 11 generates new moving image data D10 based on the frame data D2 thus read out (S102). This process of step S102 is specifically described. First, the CPU 11 refers to the scene number information D3 stored in the main memory 12, and obtains the scene number indicated by the scene number information D3. Then, the CPU 11 determines whether the save data memory 13 stores therein the moving image data D10 with the scene number obtained. When it is determined that the save data memory 13 stores no moving image data D10 with the scene number obtained, the CPU 11 adds that frame number to the frame data D2 and generates new moving image data D10 with this frame data D2.

On the other hand, when it is determined that the save data memory 13 stores the moving image data D10 with the scene number obtained, the CPU 11 reads out the moving image data D10. Then, the CPU 11 adds the frame data D2 to the moving image data D10 to generate new moving image data D10. At this time, the CPU 11 gives the frame number to the frame data D2 read out. This frame number given is a number continuous with the frame number given to the last-generated set of the frame data D2 out of all the sets of frame data D2 constituting the moving image data D10.

After that, the CPU 11 stores the newly generated moving image data D10 in the save data memory 13 (S103). Note that, when the save data memory 13 stores no moving image data D10 with the scene number obtained, the CPU 11 stores in the save data memory 13 the moving image data D10 generated in the step S102. In this case, the moving image data D10 is stored with the scene number obtained. Further, when the save data memory 13 stores the moving image data D10 with the scene number obtained, the CPU 11 updates this moving image data D10 with the moving image data D10 generated in step S102. This way, the moving image captured by the camera 17 is stored (saved) in the save data memory 13 as the moving image data D10.

After that, the CPU 11 ends the moving image saving process and causes the process to return to the main process shown in FIG. 5. In other words, the CPU 11 causes the process to proceed to step S11 of the main process.

The moving image saving process is executed when the moving image save flag D4 is in the on-state. This moving image saving process generates new moving image data D10 and store the same in the save data memory 13. Since the moving image save flag D4 is in the on-state only during the recording state, new moving image data D10 is generated and stored in the save data memory 13 only during the recording state.

[Detailed Description of Image Capturing Process: Image Combining Process]

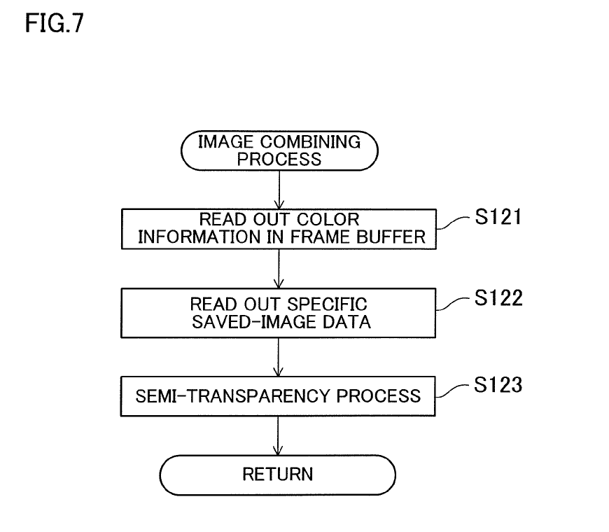

Next, the following describes the image combining process of step S12 with reference to FIG. 4B and FIG. 7. FIG. 7 is an example non-limiting flowchart of the image combining process. First, the CPU 11 reads out the color information (R, G, B) of each pixel stored in the upper display drawing area of the frame buffer 121 (S121). After that, the CPU 11 reads out the specific saved-image data D5 stored in the main memory 12 (S122).

The CPU 11 then executes the above-described semi-transparency process (S123). In this semi-transparency process, for example, the image combine ratio information D7 is read out from the main memory 12, and color mixing is conducted at a predetermined ratio (e.g., alpha value) indicated by the image combine ratio information D7, using the color information (R, G, B) of each pixel read out in step S122 and the color information (R, G, B) of each pixel indicated by the specific saved-image data D5. Further, in the semi-transparency process, the CPU 11 draws the new color information generated by this color mixing in the upper display drawing area of the frame buffer 121. This way, the specific saved-image is combined with the realtime captured-image and displayed on the upper display device 18.

After that, the CPU 11 ends the image combining process and causes the process to return to the main process shown in FIG. 5. In other words, the CPU 11 causes the process to proceed to step S13 in the main process.

As described, the image combining process is executed and the specific saved-image is displayed on the upper display device 18 in combination with the realtime captured-image, only when the image combine flag D6 is in the on-state. Since the image combine flag D6 is in the on-state only during the pausing state, the specific saved-image is combined with the realtime captured-image and displayed on the upper display device 18 only during the pausing state.

With the first embodiment, the saved-image captured immediately before pausing generation of the moving image data D10 serves as the specific saved-image which is displayed on the upper display device 18 in combination with the realtime captured-image during the pausing state. This enables the user to grasp the last-captured saved-image out of the saved-images used for generating the moving image data D10. The user is able to capture the subsequent moving image using the image capturing device 1 while grasping the last-captured saved-image.

Further, since the last-captured saved-image is made semi-transparent and displayed in combination with the realtime captured-image in the first embodiment, the user is able to adjust the position and the posture of the object in the realtime captured-image, based on the position and the posture of the object in the last-captured saved-image captured. Thus, the content of the frame data D2 of the subsequent moving image data D10 is easily made continuous with the content of the frame data D2 of the last-captured saved-image.

### Second Embodiment

Next, the following describes an image capturing process related to a second embodiment. In the image capturing process of the first embodiment, the saved-image captured immediately before the moving image saving process is paused is displayed as the specific saved-image during the pausing state. The second embodiment deals with a case where the specific saved-image to be displayed in combination with the realtime captured-image is any one of the saved-images used for generating the moving image data D10, which is selected by the user.

Further, to enable the user to select the specific saved-image, the CPU 11 reads out and reproduces the moving image data D10 to display the moving image on the upper display device 18. A modification of the image capturing device 1 receives a user-operation to select the specific saved-image while the moving image is displayed, and displays the saved-image selected by the user as the specific saved-image after the moving image data D10 is reproduced.

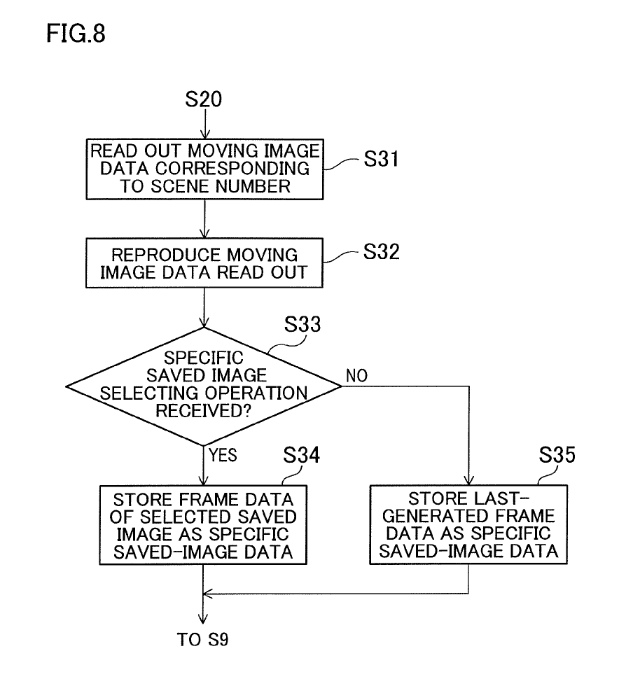

The following describes the image capturing process of the second embodiment with reference to FIG. 4A, FIG. 4B, FIG. 5A, and FIG. 8. FIG. 8 shows an example non-limiting flowchart of the main process of the image capturing process related to the second embodiment. The main process of the second embodiment is the same as that of the first embodiment except in that steps S31 to S35 shown in FIG. 8 are executed in place of step S21 shown in FIG. 5A. The following therefore describes only this difference.

In the main process of the second embodiment, the CPU 11, after step S20, refers to the scene number information D3 stored in the main memory 12 and reads out the moving image data D10 with the scene number indicated by the scene number information D3 (S31). The CPU 11 then reproduces the moving image data D10 read out (S32). Specifically, the CPU 11 successively reads out frame data D2 constituting the moving image data D10, and draws a saved-image in the upper display drawing area of the frame buffer 121 based on the frame data D2 read out. The frame data D2 is read out in the order of the frame number given to the frame data D2. This way, the moving image is displayed on the upper display device 18.

After that, the CPU 11 determines whether a specific saved-image selecting operation is received by the operation unit 20 (S33). When it is determined that the specific saved-image selecting operation is received (S33: YES), the CPU 11 stores, as the specific saved-image data D5, the frame data D2 representing the saved-image selected through the specific saved-image selecting operation in the main memory 12 (S34). Note that, in the second embodiment, the specific saved-image selecting operation is received while the moving image data D10 is reproduced, and the saved-image displayed on the upper display device 18 at the time of receiving the selecting operation is set as the specific saved-image.

After the reproduction of the moving image data D10 in step S32, the CPU 11 causes the process to proceed to step S9. This way, in the image combining process (S12) executed after step S9, the saved-image selected by the user is displayed as the specific saved-image on the upper display device 18 in combination with the realtime captured-image.

On the other hand, when it is determined that no specific saved-image selecting operation is received (S33: NO), the CPU 11 stores the last-generated set of frame data D2 out of all the sets of frame data D2 constituting the moving image data D10 in the main memory 12 as the specific saved-image data D5 (S35) as in step S21 shown in FIG. 5.

In the second embodiment, when the user conducts the specific saved-image selecting operation, the saved-image selected by the user is displayed as the specific saved-image in combination with the realtime captured-image. This enables the user to grasp the content of the specific saved-image he/she selected. Further, the moving image data D10 is reproduced before the specific saved-image is displayed. Therefore, the user is able to sufficiently grasp the content of the moving image data D10 stored in the save data memory 13.

Note that, in the second embodiment, the moving image data D10 may be generated as follows in step S102 shown in FIG. 6, when the record instructing operation is conducted during the pausing state. Namely, when the user selects the specific saved-image, the frame number to be given to the frame data D2 to be generated first after the recording state is resumed is made continuous with the frame number of the specific saved-image data D5. This way, saved-images captured in the recording state after the pausing state are inserted after the specific saved-image. In such a structure, the user is able to decide this insert position in the moving image data D10 by conducting the specific saved-image selecting operation. Further, since the saved-image selected is displayed as the specific saved-image, the user is able to grasp the specific saved-image immediately before the insert position.

(Modification)

(1) The first embodiment and the second embodiment each deal with a case where the specific saved-image is displayed in combination with the realtime captured-image during the pausing state; however, instead of or in addition to this, it is possible to display in combination with the realtime captured-image the saved-image captured immediately before the moving image saving process is stopped as the specific saved-image, after the moving image saving process is stopped. Further, when another predetermined user operation is conducted, it is possible to display in combination with the realtime captured-image the saved-image captured immediately before that predetermined user operation. For example, the other predetermined user operation is a display instructing operation by the user which instructs displaying of the specific saved-image.

(2) The first embodiment and the second embodiment each adopt an electronic finder; however, an optical finder may be adoptable, as is already mentioned hereinabove. When adopting an optical finder, for example, the optical finder may include an ocular lens and a display such as a transparent liquid crystal panel which is overlapped with the ocular lens, and the specific saved-image may be displayed on this display. In this case, the image capturing device 1 is structured so that the user is able to see the image capturing target and the specific saved-image through the transparent liquid crystal panel and the display.

(3) In the second embodiment, the saved-image captured immediately before the moving image saving process is paused is displayed as the specific saved-image in combination with the realtime captured-image; however, it is possible to display only a user-selected saved-image as the specific saved-image in combination with the realtime captured-image. Further, instead of or in addition to the structure of displaying the user-selected saved-image, a saved-image automatically (e.g., randomly) selected by the CPU 11 may be set as the specific saved-image.

(4) In the first embodiment and the second embodiment, the specific saved-image is displayed in combination with the realtime captured-image through the semi-transparency process; however, the method of combining is not limited to the semi-transparency process. Any image processing may be adoptable provided that the specific saved-image and the realtime captured-image are displayed while being overlapped with each other. For example, it is possible to extract the outline of the specific saved-image by using a known outline extracting process, thereby generating image data of a line drawing, and this line drawing may be displayed in combination with the realtime captured-image. Further, the specific saved-image does not necessarily have to be entirely displayed, and it is possible to display only a part of the specific saved-image (e.g. only the object, or the background) which is extracted by predetermined image processing.

(5) In the first embodiment and the second embodiment, the specific saved-image is displayed in combination with the realtime captured-image; however, these images do not necessarily have to be displayed in combination. The specific saved-image may be displayed along with the realtime captured-image on the upper display device 18 (finder). For example, the specific saved-image and the realtime captured-image may be displayed side-by-side instead of combining these images.

(6) In the first embodiment and the second embodiment, the image capturing device 1 is structured to enable pausing of the moving image saving process; however, the image capturing device 1 may be structured to enable only stopping of the moving image saving process, and not pausing of the process.

(7) In the image capturing process of the first embodiment and the second embodiment, audio data of the sound collected by the microphone 23 is not generated along with the moving image data D10; however, it is possible to generate the audio data along with the moving image data D10, and store the audio data generated in the save data memory 13 in association with the moving image data D10 generated.

(8) In the image capturing process of the first embodiment and the second embodiment, the operation unit is configured to receive the “image capturing mode start operation”, the “record instructing operation”, the “pause operation”, the “stop operation”, and the “image capturing mode end operation”; however, these operations may be received by the touch panel 22.

(9) In the first embodiment and the second embodiment, the sequence of the processes in the flowcharts are no more than examples, and the sequence of the processes may be modified as needed so that the same actions and effects are achieved. Further, it is not necessary to execute every single process in the flowcharts.

(10) The structure of the image capturing device 1 of the first embodiment and the second embodiment may be modified as needed. For example, the image capturing device 1 includes a built-in image capturing unit; however, this image capturing unit may be an external attachment. The image capturing device 1 does not have to be a device dedicated to capturing of a moving image. For example, the image capturing device 1 may be a portable game device, a PDA (Personal Digital Assistant), a mobile phone (including a smart phone). For example, the image capturing device 1 may be structured by a camera and a personal computer or the like. A part of the image capturing process of the image capturing device 1 may take place in another information processing device such as a server, and the image capturing system may be structured by a plurality of devices including the image capturing device 1 and the other information processing device. For example, the technology herein may include one or more servers taking at least a part of the main process and a client terminal (image capturing device 1) which is connected and in communication with the one or more servers. Alternatively, the technology herein may be a distributed system including a plurality of image capturing devices 1 connected to each other directly or via a network, each of which devices takes a part in the main process.

What is claimed is:

1. A computer-readable non-transitory storage medium, storing an image capturing program configured so that a computer of an image capturing device including an image capturing unit, a finder for enabling a user to see an image capturing target of the image capturing unit, and a storage functions as:
a moving image storage configured to store in the storage a moving image captured by the image capturing unit; and
a display controller configured to display on the finder a predetermined static image out of static images constituting a moving image stored in the storage, to enable the user to see the image capturing target.

2. A storage medium according to claim 1, wherein, of the static images constituting a moving image stored in the storage, the display controller displays as the predetermined static image at least one of a static image captured at last and a static image arbitrarily selected by the user, on the finder.

3. A storage medium according to claim 1, wherein the display controller displays the predetermined static image on the finder to enable the user to see the both predetermined static image and the image capturing target overlapped with each other.

4. A storage medium according to claim 3, wherein the display controller makes the predetermined image semi-transparent and displays the predetermined static image on the finder.

5. A storage medium according to claim 1, wherein:
the image capturing device includes an operation unit; and
when the operation unit receives a predetermined user operation by the user, the display controller displays the predetermined static image on the finder to enable the user to see the image capturing target.

6. A storage medium according to claim 5, wherein:
the predetermined user operation is a pause operation or a stop operation;
the moving image storage repetitively executes a storing process of storing in the storage a moving image captured by the image capturing unit, and pauses the storing process when the pause operation is received by the operation unit, and stops the storing process when the operation unit receives the stop operation; and
the display controller displays on the finder a static image captured immediately before the pausing or the stopping, as the predetermined static image.

7. A storage medium according to claim 1, wherein, of moving images stored in the storage, the display controller displays a moving image including the predetermined static image on the finder, and then displays the predetermined static image on the finder to enable the user to see the image capturing target.

8. An image capturing device, comprising:
an image capturing unit;
a finder configured to enable a user to see an image capturing target of the image capturing unit;
a storage;
a moving image storage configured to store in the storage a moving image captured by the image capturing unit; and
a display controller configured to display on the finder a predetermined static image out of static images constituting a moving image stored in the storage, to enable the user to see the image capturing target.

9. An image capturing system, comprising:
an image capturing unit;
a finder configured to enable a user to see an image capturing target of the image capturing unit;
a storage;
a moving image storage configured to store in the storage a moving image captured by the image capturing unit; and
a display controller configured to display on the finder a predetermined static image out of static images constituting a moving image stored in the storage, to enable the user to see the image capturing target.

10. An image display method involving an image capturing device including an image capturing unit, a finder for enabling a user to see an image capturing target of the image capturing unit, and a storage, the method comprising:
(a) storing in the storage a moving image captured by the image capturing unit; and
(b) displaying on the finder a predetermined static image out of static images constituting a moving image stored in the storage, to enable the user to see the image capturing target.
